(19) United States
(12) Patent Application Publication
(10) Pub. No.: US 2017/0130956 A1
(43) Pub. Date: May 11, 2017

(54) SYSTEM AND METHOD FOR REMOVAL OF IMPURITIES RESULTING FROM THE USE OF SODA ASH IN COAL FIRED POWER PLANTS

(71) Applicant: AECOM Technical Services, Inc., Austin, TX (US)

(72) Inventors: Sterling Gray, Austin, TX (US); James Jarvis, Austin, TX (US); Garrett Smith, Marble Falls, TX (US)

(73) Assignee: AECOM Technical Services, Inc., Austin, TX (US)

(21) Appl. No.: 15/292,233

(22) Filed: Oct. 13, 2016

Related U.S. Application Data
(60) Provisional application No. 62/253,336, filed on Nov. 10, 2015.

(51) Int. Cl. F22B 37/52; C11D 11/00; C11D 7/12; F28G 9/00; C11D 7/32

(52) U.S. Cl. CPC F22B 37/52; F28G 9/00; C11D 7/3254; C11D 7/12; C11D 11/0041

(57) ABSTRACT

When using soda ash reagent in an SBS injection system, various impurities from various possible sources can form suspended solid particles and also form scale that may foul the filtration screens, piping, reagent storage tanks, and instrumentation in the injection system. A system and method are disclosed in which a chelating agent cleaning process removes existing scale, or alternatively, prevents the particles and scale from forming. Various embodiments operate in batch or continuous modes or a combination of both.

### PRIORITY STATEMENT UNDER 35 U.S.C. §119

The present U.S. Patent claims priority pursuant to 35 U.S.C. §119(e) to U.S. Provisional Application Ser. No. 62/253,336, filed Nov. 10, 2015, in the names of Sterling Gray, James Jarvis and Garrett Smith, entitled “System and Method for Removal of Impurities Resulting from the Use of Soda Ash in Coal Fired Power Plants,” the disclosure of which is hereby incorporated by reference in its entirety.

### BACKGROUND

Sulfur in coal is oxidized in the boiler of a coal-fired power plant to produce sulfur trioxide (SO₃). In fact, SO₃ is created in small quantities during the combustion of any fuel that contains sulfur, with the quantity produced a function of the boiler design, fuel sulfur content, the excess air level, and the presence of oxidizing agents. Typically, about 1% of the fuel sulfur will be oxidized to SO₃, but it can range from 0.5% to 1.5% depending on various factors. Combustion of fuels that contain an oxidizing agent, such as certain types of fuel oil or petroleum coke, can result in even higher levels of oxidation.

When selective catalytic reduction (SCR) units are used for NOx control, additional SO₃ is generated through the oxidation of SO₂ across the SCR catalyst. The amount of SO₂ converted to SO₃ across the SCR units can vary depending on the type of catalyst used and the operating conditions, but conversion rates from 0.5% to 1.5% are considered typical.

When the flue gas is subsequently cooled, the SO₃ in the gas is converted to sulfuric acid. This sulfuric acid can condense in air heaters, in ducts and emission control devices, and it can become a very fine mist or aerosol in the plume from the stack. As a result, in addition to being highly corrosive within the air heaters, ducts and precipitators, the visible plume emanating from the stack appears as a highly visible blue-white haze, or a brown cloud, which can be carried for miles downwind.

The in-situ SBS injection technology involves the injection of a solution of sodium carbonate (i.e. soda ash), into the flue gas for the selective removal of SO₃. Sodium carbonate is injected as a solution and reacts with SO₂ in the flue gas to produce sodium bisulfite or sodium sulfite. This is illustrated by the following chemical reactions:

Na₂CO₃+2SO₂+H₂O→2NaHSO₃+CO₂ (1)

Na₂CO₃+SO₂→Na₂SO₃+CO₂ (2)

As the injected solutions are dried, solid sodium sulfite is formed as the SO₃ sorbent. The process then proceeds with the same reaction steps as the traditional SBS injection process to remove SO₃ from the flue gas. When reagent is injected in excess of the amount of SO₃, the following reactions occur to produce sodium sulfate:

Na₂SO₃+SO₃→Na₂SO₄+SO₂ (3)

If the amount of reagent injected is much less than the amount of SO₃, then sodium sulfate will continue to react with SO₃ to form sodium bisulfate:

Na₂SO₄+SO₃+H₂O→2NaHSO₄ (4)

The sodium carbonate solution is sprayed into the flue gas through dual-fluid atomizing nozzles and the moisture evaporates within a short distance of the injection point. While some important reactions occur within that very short time in the liquid phase, the majority of the SO₃ removal occurs as a solid-phase reaction with the dried particles. The particles formed are small and, due to the “popcorn” effect resulting from CO₂, SO₂, and H₂O evolution, have a very high surface area, and are therefore very reactive. The dry reaction products are removed from the gas stream with the ash particulate, normally in an emission control device.

Referring now to FIG. 1 which depicts a simplified process flow diagram of the equipment required for what is commonly known as the in-situ SBS injection technology. The sodium carbonate, or soda ash, used in the process is generally received as a dry solid. The reagent is typically delivered using a pneumatic hopper truck 101 and, upon unloading, dissolved immediately with softened water and stored as a 20-25 weight percent clear solution in a reagent solution storage tank 102.

From the reagent storage tank 102, the concentrated solution is fed to an injection pump skid and then to a metering skid, where it is diluted in-line with softened water prior to injection. The injection and metering skids are equipped with instrumentation (i.e., density, flow, etc.) and flow control valves to provide the proper flow and concentration of the diluted solution, based on the process demand signal. The use of softened water 106 is helpful for this dilution step, and in the initial dissolution of the soda ash, to minimize calcium carbonate scaling in the feed lines and nozzles. Heat tracing and insulation are required for the sodium carbonate solution streams to avoid freezing or crystallization.

The soda ash reagent used in the SBS injection system contains various impurities, including calcium, magnesium and silicates, which can dissolve during the initial soda ash dissolution step. These impurities may also come from a variety of other sources such as the water used to dissolve the soda ash. The reagent, solutions or slurries made from this soda ash, might have dissolved soda ash concentrations up to 33 weight percent. The calcium, magnesium, and silicates can precipitate, forming either a chemical scale or a suspended precipitate. The chemical scale typically contains the calcium impurity; however, in the presence of concentrated sodium carbonate, the scale can include compounds containing both calcium and sodium, and potentially, the magnesium impurity.

In some instances, the impurities can form both a chemical scale and a suspended precipitate. For example, pirssonite [CaNa₂(CO₃)₂.2H₂O], is a compound that forms both scale and suspended precipitate containing both calcium and sodium. Also, the magnesium impurity may form scale, but is often found as a suspended particulate that can foul the filtration screens that are typically employed as part of the SBS injection system. The magnesium impurity may also precipitate as the hydroxide or in various forms of magnesium silicate.

The chemical scale, which includes pirssonite, can form within the piping used to transport the soda ash reagent from the storage tank to the reagent injection location. This scale can grow to a point where it obstructs the flow of the reagent, causing excessive pressure drop or reduced flow. In addition, the scale can form within process instrumentation, such as mass flow meters, or Coriolis meters, used to measure the reagent density and flow rates that are used to control the SBS injection system. Indeed, pirssonite scaling is a common problem encountered during the production of the soda ash reagent itself. The scale is typically removed by shutting down the affected process, draining the liquid from the piping, and then cleaning the piping with a strong acid such as citric acid or sulfamic acid.

### SUMMARY OF THE INVENTION

Various embodiments of the current invention incorporate a chelating agent, such as, for example, ethylenediaminetetraacetic acid (EDTA) or any of its salts to mitigate the suspended solids formation or scale formation effects of the impurities in the soda ash, or added to the soda ash. The chelating agent dissolves the existing precipitated impurities, prevents the initial precipitation of the impurities, or both dissolves the existing and prevents any new precipitation of the impurities. In certain embodiments, the chelating agent also dissolves and/or prevents precipitation of other compounds including pirssonite and magnesium silicates.

One advantage of using chelating agents rather than acid cleaning is that the SBS injection system can continue to operate during the cleaning process. That is, it is not necessary to shut down and drain the equipment, and the SBS system can continue to function normally while the cleaning progresses.

There are a number of embodiments in which the process of using chelating agents to remove scale and precipitates may be used. In one embodiment, excess chelating agent can be added to the soda ash storage tank on a shorter-term basis for the primary purpose of removing existing scale. An initial charge of the chelating agent is added to the storage tank at an amount that is in excess relative to the soda ash inventory in the storage tank. In some embodiments, additional chelating agent may also be added over time, again in excess, relative to any make-up soda ash that is added to the tank during the cleaning process. A portion of the total chelating agent added to the tank chelates the dissolved calcium and magnesium that either entered the tank with the existing soda ash inventory or that is added to the tank as make-up soda ash. Then, the remaining “excess” chelating agent is available to dissolve and chelate existing scale or precipitated impurities.

The cleaning process described above has been conducted at molar ratios of approximately 2.0 moles of chelating agent to the total moles of calcium, magnesium and other divalent metals. Molar ratios above 2.0 can be used, however, any chelating agent that is in excess of a molar ratio of 1.0 will serve to dissolve any existing scale. The cleaning requires time ranging from a few days to a few weeks to dissolve existing scale, and the time required depends on the excess chelating agent concentration, the amount of scale present, and any other unique objectives for the cleaning process.

In some embodiments, in addition to the scale-dissolving method described above, the chelating agent may be added to the soda ash tank on a longer-term basis for the primary purpose of preventing precipitation of the soda ash impurities. If the soda ash system is free of existing scale, then the molar ratio of the chelating agent can be less than 1.0, because it is not necessary to completely chelate all of the impurities to prevent them from precipitating. The minimum required molar ratio depends on the concentrations of the impurities that are present.

The amount of chelating agent required for either the scale-removing or scale-preventing approach depends, in part, on the concentrations of calcium, magnesium and other divalent metals in the soda ash. The soda ash supplier can provide analytical information which can be used to estimate the amount of chelating agent required to chelate the impurities present in the soda ash material.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF DRAWINGS

For a more complete understanding of the present invention, and the advantages thereof, reference is now made to the following descriptions taken in conjunction with the accompanying drawings, in which:

FIG. 1 is a simplified process flow diagram of the equipment required for the in-situ SBS injection technology;

FIG. 2 is a schematic block diagram depicting one embodiment of a chelating agent, in solid or liquid form, being added to the SBS injection system;

FIG. 3 is a schematic block diagram depicting an alternative embodiment of a chelating agent, in solid or liquid form, being added to the SBS injection system;

FIG. 4 is a graph showing the effect of adding chelating agent on the pump flow in the SBS system at a coal fired power plant;

FIG. 5 is a screenshot of a graph showing the effect of adding the chelating agent on the pump flow rate and the pump discharge pressure in the SBS injection system at a coal fired power plant; and

FIG. 6 is a graph showing the effect of adding the chelating agent on the density instrumentation in the SBS system at a coal fired power plant.

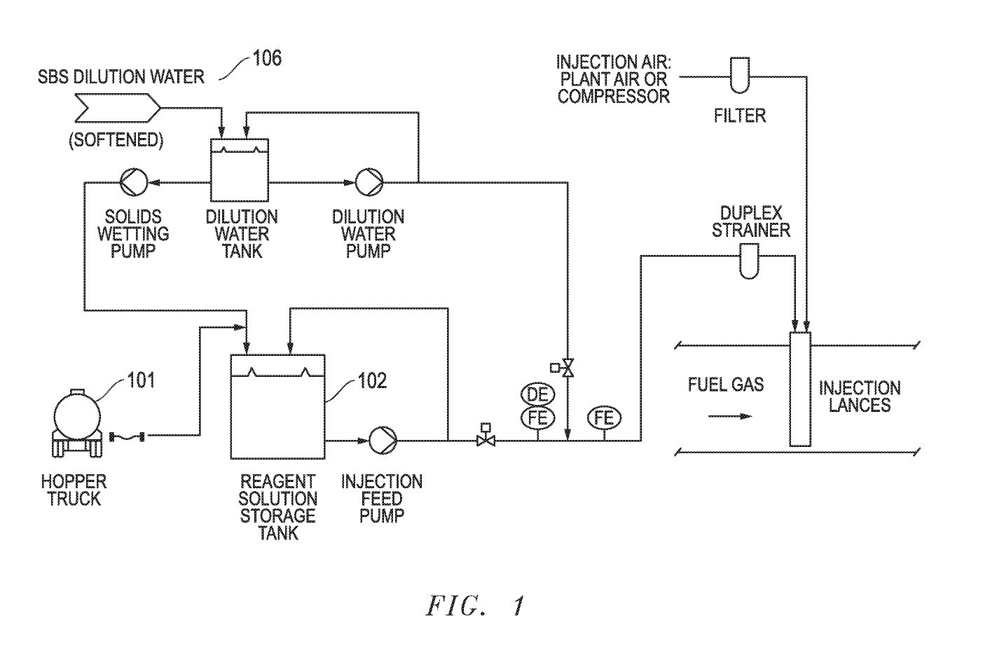

### DETAILED DESCRIPTION OF THE PREFERRED EMBODIMENTS

The present invention is generally directed to cleaning scale and dissolving suspended solids and/or preventing any additional scale or suspended solids from forming in the process equipment used in what is referred to as the SBS injection (SBS) system. In certain embodiments of the invention, chelating agent may be added in a variety of different ways using a variety of different methods. It should be appreciated, therefore, that the present invention provides many applicable inventive concepts that can be embodied in a wide variety of contexts other than cleaning scale and dissolving suspended solids and/or preventing any additional scale or suspended solids from forming in the process equipment used in an SBS injection (SBS) system. Accordingly, the specific embodiments discussed are merely illustrative of specific ways to make and use the invention, and do not limit the scope of the invention. In addition, the following terms shall have the associated meaning when used herein:

“emission control device” means any device for the removal of emissions from a flue gas stream, including an electrostatic precipitator, a fabric filter, and a wet scrubber;

“flue gas” means an exhaust gas that is produced from an industrial process and includes both gas that will be used in connection with the process from which it is produced or even another related process (e.g., to produce heat), which will exit into the atmosphere via a stack for conveying waste exhaust gases from an industrial process. The flue gas can be produced from any industrial process such as a power generating process, metal smelting process and the like;
“injecting” or “injection” means the introduction of a material into a flue gas from a point external to the duct work containing the flue gas, and includes the introduction of a liquid phase solution or a powder into the flue gas, and the placement of a solid in the flue gas stream;
“SBS injection system” means any process in which a solution made up, in whole or in part, of sodium carbonate, or soda ash, into a flue gas for the selective removal of SO₃ or for any other purpose.
“sulfuric acid” means sulfuric acid, present in either the vapor phase or condensed as a liquid, and sulfur trioxide, which is the anhydrous form of vapor-phase sulfuric acid.

As previously described, the chelating agent used in this invention may be EDTA. In some embodiments, the chelating agent may include any one, or a mixture of two or more, members of the family of compounds of aminopolycarboxylic acids and other chelating agents such as, but not limited to, N-(1,2-dicarboxyethylene)-asparagine acid, polyaspartic acid, ethylenediamine-disuccinic acid, N,N-bis(carboxymethyl)-glutamic acid, and/or methylglycine-diacetic acid. Alternatively, or in addition, the chelating agent or mixture of chelating agents may be a member of the family of compounds of porphine, or a member of the family of compounds of sulfur-containing alcohols and other chelating agents such as, but not limited to, 2,3-dimercapto-1-propanol.

In various embodiments, the chelating agent may be dissolved into a liquid phase solution before addition into the soda ash system and in other embodiments, the chelating agent is added into the soda ash system as a dry powder, either directly or through the mixing with and addition of dry soda ash reagent. As discussed in more detail below, in some embodiments the chelating agent may be added in a molar ratio above 1.0, to remove said constituents that are already present within the system, wherein there is the same number of moles of chelating agent as there are impurities from the existing soda ash inventory. In other embodiments, the chelating agent is added continuously to the soda ash system, at any molar ratio, and in particular at molar ratios less than 1.0, to prevent precipitation of said constituents

Referring now to FIG. 2, which depicts a schematic block diagram of one embodiment of the invention suitable for either the removal of existing scale or the prevention of new scale. The chelating agent is added to the SBS injection system by any means possible, such as: pre-mixed with the soda ash 2, or added on site to the soda ash then added to the soda ash storage tank 4, added directly to the soda ash storage tank 5, added to a stream flowing into the soda ash storage tank such as the recycle stream 6, or added directly to the soda ash stream being fed to the SBS injection 7. The chelating agent may be handled dry or added to solution with water to varying concentrations for addition to the SBS injection system. Some of the chelating agent is used to chelate the calcium and magnesium that entered the tank with the existing soda ash inventory, or that enters the tank with make-up soda ash. Chelating agent in excess of this amount can dissolve existing scale or precipitated solids.

The amount of chelating agent to add to the SBS injection system depends on the cleaning objectives. If there is existing scale, then the minimum amount of chelating agent to add is calculated as being equal to the sum of the total molar concentrations of divalent metals (i.e., the calcium, magnesium, and lesser quantities of other divalent metal impurities) that were present in the soda ash that is contained in the storage tank at the start of the cleaning process. This is a molar ratio of 1.0 where there is the same number of moles of chelating agent as there are impurities from the existing soda ash inventory. Any chelating agent added in excess of this amount will dissolve and chelate existing precipitated impurities including scale and suspended solids.

If there is no existing scale, then the precipitation of new scale or precipitated solids may be prevented using a chelating agent total molar concentration of 1.0 or less. Here, the objective is to add sufficient chelating agent such that the remaining unchelated concentrations of impurities do not result in supersaturated conditions with respect to potential precipitating species. Analytical information provided by the soda ash supplier can be used to estimate the amount of chelating agent required to chelate the impurities present in a given soda ash material. The minimum required molar ratio may be as low as 0.2 in some cases in a clean or new system to prevent the formation of scale and suspended precipitated particles and in general keep the system free from scale.

Addition of chelating agent to clean the SBS injection system has typically been performed at a molar ratio of approximately 2.0, where the chelating agent concentration in excess of a molar ratio of 1.0 serves to dissolve the existing scale. This strategy will serve to dissolve existing scale as long as the molar ratio of chelating agent to divalent metals exceeds approximately 1.0. A period ranging from a few days to a few weeks may be required to dissolve existing scale, and the time required depends on the excess chelating agent concentration, the amount of scale present, and the specific objectives for the cleaning process.

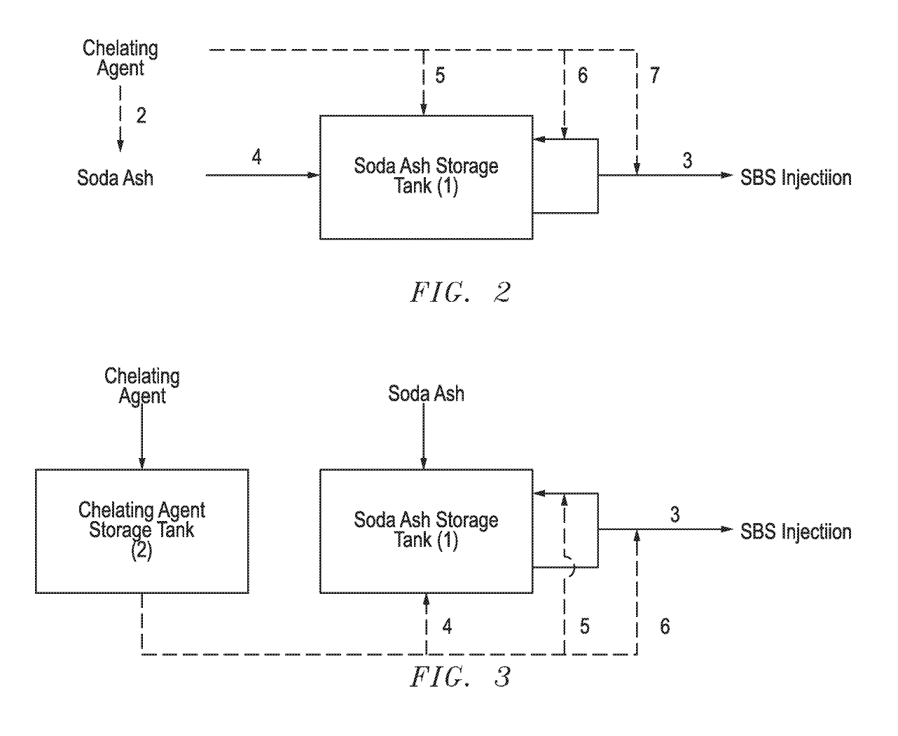

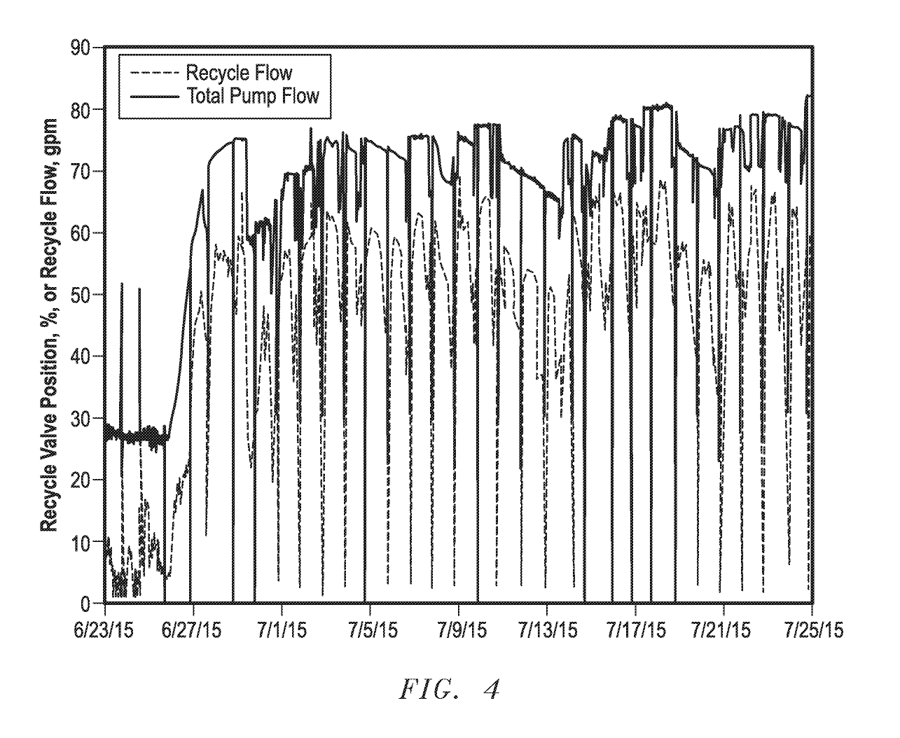

Another embodiment of the invention is shown in FIG. 3 where the chelating agent is stored on site in a chelating agent storage tank and is added to the SBS injection system on a continuous or intermittent basis by any method, for example: added directly to the soda ash storage tank 4, added to a stream flowing into the tank such as the recycle stream 5, or added to the soda ash stream being fed to the SBS injection 6. The amount of chelating agent to add to the SBS injection system in this embodiment is determined in the same way as was previously described, and the difference here is that the chelating agent is added from an on-site chelating agent storage tank.

The chelating agent can be introduced into the soda ash system in many different ways in which the agent will work to clean impurities at the point of introduction and downstream thereof. The chelating agent can conceivably be added anywhere into the system for the purpose of cleaning impurities or preventing impurity formation downstream in the SBS injection system from the point of injection. The chelating agent can be added to the soda ash storage tank directly as a dry solid or could be added to the dry soda ash prior to delivery by the soda ash supplier. The chelating agent may also be dry fed or dissolved in water and added to any point within the SBS injection system. This method for removal of impurities resulting from the use of soda ash therefore is intended to capture any and all conceivable means and methods of introducing the chelating agent into the soda ash system and the method for removal of impurities would therefore occur from that point forward throughout the system.

It has been demonstrated that relatively low concentrations of chelating agent could prevent the precipitation of soda ash impurities. For example, chelating agent molar ratios ranging from 0.1 to 2.5 inhibited the precipitation of soda ash impurities. The cleaning process was employed at three full-scale SBS injection system applications where scale formation was restricting the soda ash solution flow through the process piping or interfering with the measurements made by online instrumentation. Data from these three applications are show and described below in Examples 1, 2 and 3.

### EXAMPLE 1

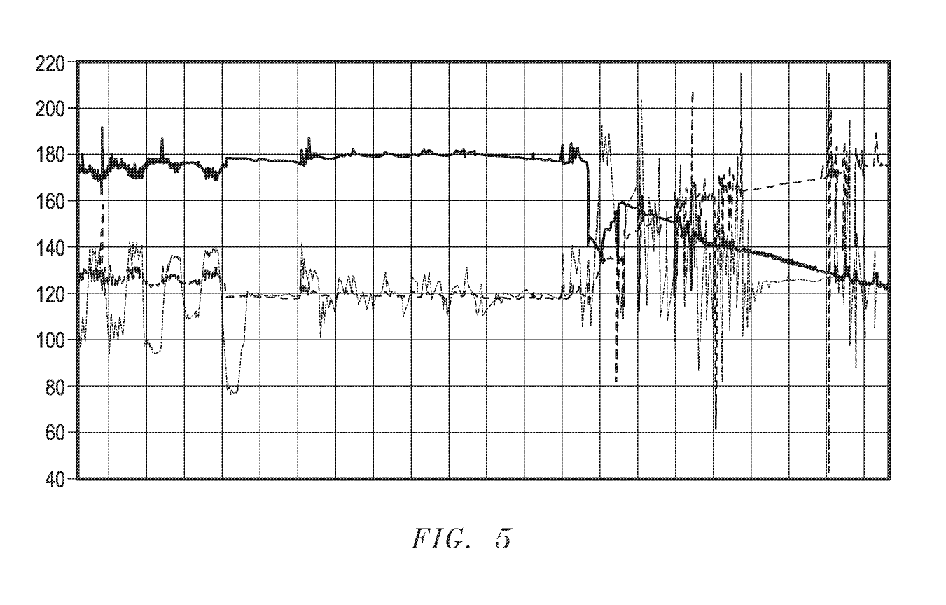

The SBS Injection system at the first power plant was experiencing low flow from the system's pump due to excessive scale that had developed throughout the process piping. The pump flow data in FIG. 4 between Jun. 23, 2015 and Jun. 27, 2015 shows that both the Recycle Flow and Total Pump Flow are less than 30 gpm. The system was designed to operate at a total pump flow rate of 75 gpm. Chelating agent addition was started on Jun. 23, 2015, raising the chelating agent-to-metals molar ratio to 1.0. On Jun. 24, 2015 additional chelating agent was added raising the chelating agent-to-metals molar ratio in the soda ash tank to 2.0-2.5 to begin dissolving precipitated impurities and scale. After approximately two days the additional chelating agent began to show the effects of reducing the scale in the injection system so that the pump flow rate increased. This result may be noted in the graph shown in FIG. 4 when the Recycle Flow and the Total Pump Flow rates increased on Jun. 26, 2015 and pump flow ultimately returned to the design flow rate of 75 gpm on approximately Jun. 28, 2015. The chelating agent concentration was maintained at a 2.0-2.5 molar ratio for approximately one month to be confident that all the scale in the system was completely cleaned and removed.

### EXAMPLE 2

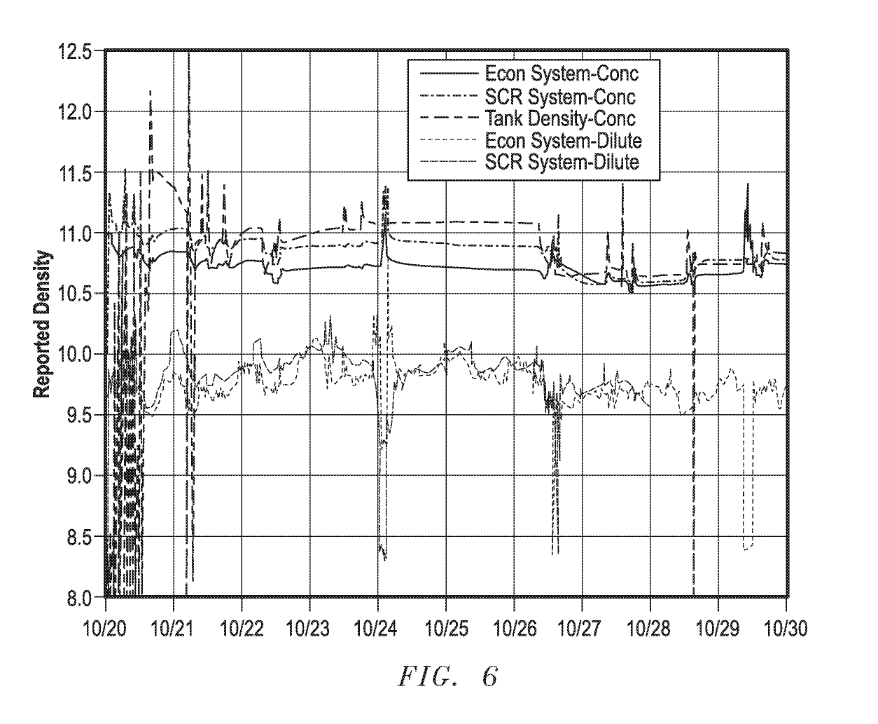

The second power plant's SBS injection system was experiencing low flow from the system's pump and elevated pump discharge pressure due to excessive scaling throughout the process piping. This is shown in FIG. 5 where the pump flow rate is at approximately 120 on Aug. 31, 2015 at roughly 7:00 pm and the pressure is at approximately 280 psig. Chelating agent injection was initiated somewhat earlier in the day on Aug. 31, 2015. After injection started the chelating agent-to-metals molar ratio was held near 2.0 for the duration of the cleaning process of 18 days. The pump flow rate increased and the pump discharge pressure decreased relatively quickly, i.e., within 2-3 hours, as the chelating agent began to clean the scale from the system. However the pump flow rate did not reach its design value of near 180 psig until after chelating agent was added for approximately 10 days. The last day that chelating agent was added to the soda ash tank was on Sep. 17, 2015.

### EXAMPLE 3

Whereas in Examples 1 and 2, the primary issue was low pump flow and high pump discharge pressure, the issue caused by scaling at the third power plant's SBS system was shown by lack of agreement among the density instruments. At the third power plant, there are three density meters (one for the soda ash tank itself, and two more for the soda ash feed to the two separate injection locations on the generating unit at the plant). The three density meters should indicate density measurements that are generally very similar. However, as shown by the graph in FIG. 6, the meters do not correlate well for the data readings from Oct. 20, 2015 through late in the day on Oct. 26, 2015. The difference in the measurement results can be as much as 0.5 pounds per gallon (not including spikes in the measurements, which can be considered as outlier data points and eliminated from use). This difference in the density measurements corresponds to an error in the calculated soda ash concentration, which is calculated from the measured density, of up to 25%. Chelating agent addition was initiated on October 26, and within a few hours of addition, the three concentrated density meters came into much better agreement, also as shown by the graph in FIG. 6. The density values measured after Oct. 27, 2015 differ by less than 0.15 pounds per gallon, which translates into significantly less error in the calculated soda ash concentration. This improvement in the agreement of these results is obvious upon inspecting the proximity of the three lines of density measurements before and after chelating agent was added on Oct. 26, 2015. Before addition was started, the density values were much farther apart as compared to the values after addition was started on Oct. 26, 2016. The removal of scale from within the elements of the density instruments caused their measurements to converge to a similar, accurate value.

While the present device has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible methods and systems available for the removal of impurities in flue gas and soda ash in a coal fired power plant, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for removing scale from the inside of equipment in a coal fired power plant, comprising:
injecting soda ash into a flue gas stream flowing through equipment in a coal fired power plant, wherein impurities have formed scale on the inside of the equipment;
adding a chelating agent to the soda ash;
injecting the soda ash with the chelating agent into the flue gas stream;
allowing the chelating agent to chemically react with the scale on the inside of the equipment, thereby dissolving the scale between the point at which the soda ash and chelating agent are added and the downstream end of the equipment through which the flue gas stream is flowing and allowing the dissolved scale to be passed through and out of the equipment.

2. The method of claim 1, wherein the impurities resulted from the use of soda ash without a chelating agent.

3. The method of claim 1, wherein the impurities resulted from sources other than soda ash.

4. The method of claim 1, wherein the impurities are calcium, magnesium and silicates.

5. The method of claim 1, wherein the scale consists of one or more of pirssonite, magnesium silicates and calcium carbonate.

6. The method of claim 1, wherein the chelating agent is EDTA.

7. The method of claim 1, wherein the chelating agent is an EDTA salt.

8. The method of claim 1, wherein the chelating agent is one or more of aminopolycarboxylic acids, N-(1,2-dicarboxyethylene)-asparagine acid, polyaspartic acid, ethylenediamine-disuccinic acid, N,N-bis(carboxymethyl)-glutamic acid and methylglycine-diacetic acid.

9. The method of claim 1, wherein the chelating agent is member of the family of compounds of porphine.

10. The method of claim 1, wherein the chelating agent is a member of the family of compounds of sulfur-containing alcohols.

11. The method of claim 1, wherein the chelating agent is 2,3-dimercapto-1-propanol.

12. The method of claim 1, wherein the chelating agent is dissolved into a liquid phase solution before it is added to the soda ash.

13. The method of claim 1, wherein the chelating agent is added to the soda ash as a dry powder.

14. The method of claim 1, wherein the ratio of the number of moles of chelating agent to the number of moles of divalent metals in the impurities is greater than 1.0, thereby removing scale already present within the equipment.

15. The method of claim 1, wherein the chelating agent is added continuously to the soda ash and the ratio of the number of moles of chelating agent to the number of moles of divalent metals in the impurities is less than 1.0, thereby reducing the saturation levels of the scale compounds and preventing precipitation of scale within the equipment.

16. The method of claim 1, wherein the chelating agent is added to the soda ash continuously to prevent precipitation of scale within the equipment, and also added to the soda ash as a batch, thereby removing scale already present within the equipment.

17. A method for removing precipitates from the inside of equipment in a coal fired power plant, comprising:
injecting soda ash into a flue gas stream flowing through equipment in a coal fired power plant, wherein impurities form precipitates inside of the equipment;
adding a chelating agent to the soda ash;
injecting the soda ash with the chelating agent into the flue gas stream;
allowing the chelating agent to chemically react with the precipitates formed inside the equipment, thereby dissolving the precipitates between the point at which the soda ash and chelating agent are added and the downstream end of the equipment through which the flue gas stream is flowing and allowing the dissolved precipitates to be passed through and out of the equipment.

18. The method of claim 17, wherein the impurities are one or more of calcium, magnesium and silicates.

19. The method of claim 17, wherein the precipitates consist of one or more of pirssonite, magnesium silicates and calcium carbonate.

20. The method of claim 17, wherein the chelating agent is EDTA.

21. The method of claim 17, wherein the chelating agent is an EDTA salt.

22. A system for removing scale from the inside of equipment in a coal fired power plant, comprising:
equipment in a coal fired power plant having flue gas flowing therethrough, the equipment having scale on the inside surface thereof resulting from soda ash in the flue gas;
a soda ash source for supplying soda ash into the flue gas, the soda ash including one or more impurities from any source;
a chelating agent configured to be combined with the soda ash, wherein when the chelating agent is combined with the soda ash and the soda ash and chelating agent are injected into the flue gas, the chelating agent chemically reacts with the scale on the inside surface of the equipment, thereby dissolving the scale between the point at which the soda ash and chelating agent are added and the downstream end of the equipment through which the flue gas stream is flowing and allowing the dissolved scale to be passed through and out of the equipment.

23. The method of claim 22, wherein the impurities consist of one or more of calcium, magnesium and silicates.

24. The method of claim 22, wherein the scale consists of one or more of pirssonite, magnesium silicates and calcium carbonate.

25. The method of claim 22, wherein the chelating agent is EDTA.

26. The method of claim 22, wherein the chelating agent is an EDTA salt.

27. The method of claim 22, wherein the chelating agent is one or more of aminopolycarboxylic acids, N-(1,2-dicarboxyethylene)-asparagine acid, polyaspartic acid, ethylenediamine-disuccinic acid, N,N-bis(carboxymethyl)-glutamic acid and methylglycine-diacetic acid.

28. The method of claim 22, wherein the chelating agent is member of the family of compounds of porphine.

29. The method of claim 22, wherein the chelating agent is a member of the family of compounds of sulfur-containing alcohols.

30. The method of claim 22, wherein the chelating agent is 2,3-dimercapto-1-propanol.

31. The method of claim 22, wherein the chelating agent is dissolved into a liquid phase solution before addition into the soda ash.

32. The method of claim 22, wherein the ratio of the number of moles of chelating agent to the number of moles of divalent metals in the impurities is greater than 1.0, thereby removing scale already present within the equipment.
